(19) United States
(12) Patent Application Publication
(10) Pub. No.: US 2009/0162495 A1
(43) Pub. Date: Jun. 25, 2009

(54) Derivatives of Di-Carbonyl Aromachemicals

(75) Inventor: Luca Turin, London (GB)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: FLEXITRAL INC, CHANTILLY, VA (US)

(21) Appl. No.: 11/995,392

(22) PCT Filed: Jul. 12, 2006
(86) PCT No.: PCT/US06/26828

§ 371 Date: Jul. 17, 2008

Related U.S. Application Data
(60) Provisional application No. 60/698,013, filed on Jul. 12, 2005.

(51) Int. Cl. A23L 1/237; A23L 1/22; B65D 85/00

(52) U.S. Cl. 426/87; 426/535

(57) ABSTRACT

An improved method for imparting a flavor to a product, the method comprising adding to the product an organoleptically effective amount of a dicarbonyl or a mixture thereof, the improvement comprising substituting for the dicarbonyl, an organoleptically acceptable derivative thereof having the formula (I) or (II), wherein m=0, 1 or 2, n=1 or 2, R¹ and R² are, independently, linear or branched saturated C1-4 alkyl, with the proviso that both of R¹ and R² may not be methyl, and X is a counterion. Typically, R¹ and R² are methyl (with the above proviso), ethyl, propyl (e.g. n- or i-propyl) or butyl (e.g. n-, i- or t-butyl), or an organoleptically acceptable salt thereof, as well as compositions for carrying out the method and products and articles of manufacture comprising the additive.

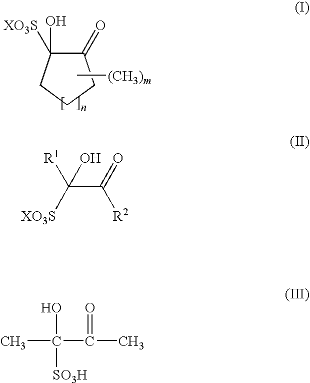

### FIELD OF THE INVENTION

The present invention relates to derivatives of certain aromachemicals

### BACKGROUND OF THE INVENTION

There are a large number of aromachemicals that are used to modify the flavor and/or fragrance of food and drink products and/or to modify the fragrance of products such as consumer products. Some aromachemicals are highly reactive and may potentially be dangerous to the health of people working in environments in which these products are used. It is an object of the present invention to provide derivatives of a harmful compound which is far less likely to be a danger to health but which can also be used to provide flavors and fragrances.

One flavor that is very popular with consumers is butter flavor. Butter-flavored foods are highly desirable and widely consumed. For example, in recent years butter-flavored microwavable popcorn has become extremely popular.

A number of additives have been developed over the years that impart a butter flavor to food products. For example, Commercial Creamery Co. has developed a new butter flavor comprising an enzyme modified butter powder. Also on the market as a butter substitute is Acetyl Methyl Carbinol (Acetoin).

The most popular butter flavor additive employed today, however, is diacetyl [2,3-butanedione] which has the formula:

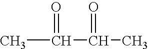

Diacetyl [sometimes marketed as “Starter Distillates”] has a FTV of flavor threshold of 0.10 mg/L. Carbonyl compounds make a particularly significant contribution to the flavor of fermented dairy products. Diacetyl is one of the most important carbonyls to the flavors of these products. It has a buttery, nut-like flavor. Diacetyl may be produced via the fermentation of citrate-containing material bacterial culture containing alpha-acetolactic acid, acidifying the bacterial culture which is then water vapor distilled in the presence of oxygen for oxidation of alpha-acetolactic acid to diacetyl. [Source book of Flavors, Reineccius, G, Ed. 1994 Chapman and Hall, New York].

Butter-flavored foods are highly desirable and widely consumed. For example, in recent years butter-flavored microwavable popcorn has become extremely popular. It is widely recognized within the art of producing and using butter flavors that diacetyl and butyric acid are key flavor components easily lost via evaporation (Merker, U.S. Pat. No. 2,773,772; Buhler, U.S. Pat. No. 3,653,921; Millisor, U.S. Pat. No. 4,384,008; Bakal, U.S. Pat. No. 4,414,229; and Darragh, U.S. Pat. No. 3,867,556). Buhler, U.S. Pat. No. 3,653,921, for example, notes the prior art has suggested the incorporation of selected lactones, diacetyl, constituents of cultured butter, short-chain fatty acids and alcohols and other chemical compounds into oleaginous foodstuffs to impart a butter flavor. Millisor, U.S. Pat. No. 4,384,008, discloses a specific formulation made from diacetyl, several short-chain fatty acids and lactones for preparing a butter flavored oil.

Diacetyl (2,3 butanedione) is an extremely powerful and highly volatile (b.p. 88C) odorant. The National Institute for Occupational Safety and Health (NIOSH), a federal workplace safety agency, believes that diacetyl may be the component of butter flavoring responsible for more than a dozen cases of a respiratory illness called “popcorn workers' lung” it has discovered in the past four years [Niosh Health Hazard Evaluation Report, HETA-2002-0408-2915 (October, 2003).

Diacetyl is a reactive molecule, attacks arginine residues in proteins and is known to inhibit enzymes. NIOSH describes the adverse effects of diacetyl: Potential symptoms: Eye, mucous membrane, respiratory system, skin irritation; persistent cough, phlegm production, wheezing, dyspnea (shortness of breath); unusual fatigue; episodes of mild fever or generalized aches; severe skin rashes. Health Effects: Irritation-Eyes, Nose, Throat, Skin (HE15); Suspected cumulative lung damage—bronchiolitis obliterans (HE10) Affected organs: Eyes, respiratory system, skin.

Other authors have also pointed out the dangers of exposure to diacetyl: DiFolco, Forum Casualty & Environment, Issue no. 14-Dec., 2004; Fix, BrewingTechniques' July/August 1993 [“—the involvement of diacetyl in sarcina sickness was discovered early, but it was not until 1939 that Shimwell linked this compound with the taste and smell of butter—”]; Kreiss, K., Gomaa, A., Kullman, G., Fedan, K., Simoes, E. J. and Enright, P. L.: Clinical bronchiolitis obliterans in workers at a microwave-popcorn plant. New Eng. J. Med. 347(5): 330-338, 2002; Lockey, J., McKay, R, Barth, E., Dahlsten, J. and Baughman, R.: Bronchiolitis obliterans in the food flavoring industry [abstract]. Am. J. Respir. Crit. Care Med. 165: A461, 2002; Parmet, A. J. and Von Essen, S.: Rapidly progressive, fixed airway obstructive disease in popcorn workers: a new occupational pulmonary illness? [Letter] J. Occup. Environ. Med. 44(3): 216-218, 2002; Hubbs, A. F., Battelli, L., Goldsmith, W. T., Porter, D. W., Frazer, D., Friend, S., Schwegler-Berry, D., Mercer, R. R., Reynolds, J. S., Grote, A., Castranova, V., Kullman, G., Fedan, J. S., Dowdy, J. and Jones, W. G.: Necrosis of nasal and airway epithelium in rats inhaling vapors of artificial butter flavoring. Toxicol. Appl. Pharmacol. 185: 128-135, 2002. Boggaram, V. and Mannervik, B.: Essential arginine residues in the pyridine nucleotide binding sites of glutathione reductase. Biochim. Biophys. Acta 701(1): 119-126, 1982; Borders, C. L. Jr., Saunders, J. E., Blech, D. M. and Frovich, I.: Essentiality of the active-site arginine residue for the normal catalytic activity of Cu. Zn superoxide dismutase. Biochem. J. 230(3): 771-776, 1985. Riordan, J. F.: Arginyl residues and anion binding sites in proteins. Mol. Cell. Biochem. 26(2): 71-92, 1979.

Other di-carbonyl compounds are also used as aromachemicals, e.g., 1,2-cyclohexanedione, 3,4-dimethyl-1,2-cyclopentaneadione, 3,5-dimethyl-1,2-cyclopentanedione, 2,3-heptanedione, 2,3-hexanedione, 3,4-hexanedione, 1-methyl-2,3-cyclohexanedione, 3-methylcyclopentane-1,2-dione, 5-methyl-2,3-hexanedione.

It is an object of the present invention to provide substitutes for these di-carbonyl compounds that imparts the same flavors and odors to food products as the compounds per se without any attendant disadvantages.

### SUMMARY OF THE INVENTION

The above and other objects are realized by the present invention, one embodiment of which relates to an improved method for imparting a flavor to a product, the method comprising adding to said product an organoleptically effective amount of a di-carbonyl compound, wherein the improvement comprises substituting for the di-carbonyl compound, an organoleptically acceptable derivative thereof having the formula:

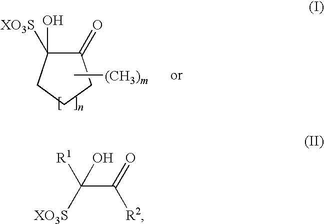

wherein m=0, 1 or 2, n=1 or 2, R¹ and R² are, independently, linear or branched saturated C₁₋₄ alkyl, with the proviso that both of R¹ and R² may not be methyl, and X is a counterion of the sulfiting agent employed to synthesize the derivative. Typically, R¹ and R² are methyl (with the above proviso), ethyl, propyl (e.g. n- or i-propyl) or butyl (e.g. n-, i- or t-butyl). Preferably, X is H, an alkali metal or an ammonium salt. Most preferably, X is Na or K.

A still further embodiment of the invention concerns a product comprising an effective amount of the above additive to impart aromachemical properties thereto.

Another embodiment of the invention relates to an article of manufacture comprising the above-described product.

A still further object of the invention relates to an article of manufacture in kit form comprising separate packaging materials and a product contained within one of the packaging materials, and an additive described above contained within the other of the packaging materials.

An additional embodiment of the invention relates to a composition in unit dosage form comprising a derivative described above and an acceptable carrier therefore, wherein the derivative is present in said composition in an amount sufficient to impart aromachemical properties to a product to which the composition is added.

### DETAILED DESCRIPTION OF THE INVENTION

Diacetyl is known to form an adduct with sodium hydrogen sulfite [2-butanesulfonic acid, 2-hydroxy-3-oxo-, monosodium salt—CAS 13489-36-6]. See also French patent 2,845,903. This adduct is in equilibrium with the starting materials and, in practice, releases small amounts of diacetyl and sulfite continuously. The above-mentioned French patent discloses that the adduct is useful in hair care products as a straightening agent. The vapor pressure of the diacetyl adduct is negligible, thereby resulting in little or no odor. It is usually obtained and used in the form of a water-soluble salt, such as, e.g., an alkali metal (sodium) salt. Since it is water soluble, it can therefore be sprayed directly onto foodstuffs safely. The flavor imparted by the adduct is dominated by diacetyl, since at low concentrations, the sulfite taste and flavor is imperceptible.

Methods for the preparation of the adduct are well known. Briefly, diacetyl is. dissolved in water and an equimolar amount of sodium hydrogen sulfite (i.e., bisulfite) is added gradually over a period of 20 minutes. The color of the reaction mixture turns from yellow to white. At completion of the reaction, the water is evaporated and the adduct is obtained as a crystalline white powder with virtually no odor.

Suitable sulfite or sulfite generating species for use in this reaction include water-soluble sulfites, bisulfites, hydrosulfites, metabisulfites and sulfur dioxide. For example, ammonium or alkali metal, particularly sodium or potassium sulfites, bisulfites, hydrosulfites and metabisulfites. Particularly preferred are sodium metabisulfite, sodium sulfite, sodium bisulfite and sodium hydrosulfite, potassium sulfite, potassium bisulfite, potassium hydrosulfite and potassium metabisulfite, ammonium sulfite and ammonium bisulfite and sulfur dioxide. Sulfites and metabisulfites of alkaline earth metals such as calcium and barium may also be used. Sulfites and sulfite generating species which produce sodium salts are preferred.

The reaction can be summarized as follows:

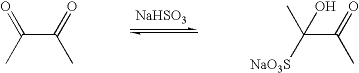

This adduct is in equilibrium with the starting materials and, in practice, releases small amounts of diacetyl and sulfite continuously. These same methods are also applicable for the formation of sulfite adducts of other diones such as, e.g., 1,2-cyclohexanedione, 3,4-dimethyl-1,2-cyclopentaneadione, 3,5-dimethyl-1,2-cyclopentanedione, 2,3-heptanedione, 2,3-hexanedione, 3,4-hexanedione, 1-methyl-2,3-cyclohexanedione, 3-methylcyclopentane-1,2-dione, 5-methyl-2,3-hexanedione. These aromachemicals are illustrated below.

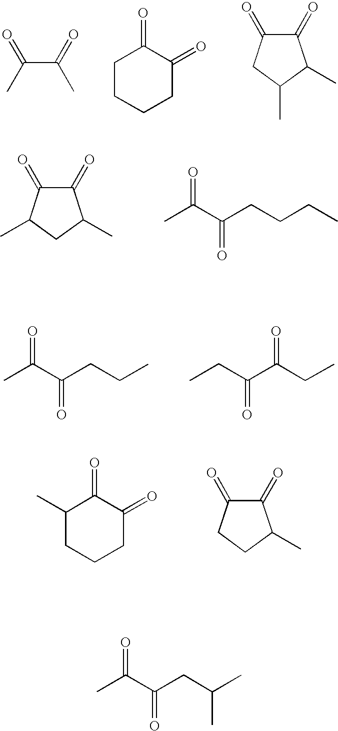

The preferred compounds of the invention are the sulfite adduct salts of these compounds (referred hereinafter as the “sulfite adducts”). The vapor pressures of the adducts are negligible, thereby resulting in little or no odor. They are usually obtained and used in the form of a water-soluble salt, such as, e.g., an alkali metal (sodium) salt. Since they are water soluble, they can therefore be sprayed directly onto foodstuffs safely. Thus, the adducts act as proflavorants or profragrances.

The term “aromachemcial” refers to a compound which has fragrance and/or flavor characteristics. For example, 3,4-dimethyl-1,2-cyclopentanedione has a sweet maple caramel sugar, fenugreek, licorice smell and flavor; 3,5-dimethyl-1,2-cyclopentadione has a brown, sweet, sugary, maple caramellic smell and flavor; 2,3-heptanedione has a buttery, cheesy, sweet, nutty, fruity, creamy, caramel smell and flavor; 3-methylcyclopentane-1,2-dione has a caramellic-maple smell and flavor; 5-methyl-2,3-hexanedione has a buttery, cheesy, sweet, nutty, fruity smell and flavor.

It will be understood by those skilled in the art that the adduct (or its salts) may be incorporated into any product or article manufactured therefrom much in the same manner and in the amounts employed in the industry for incorporating the di-carbonyl compound therein. Moreover, any product or article which may be enhanced by incorporating di-carbonyls therein may be also be treated with the adducts of the invention.

For the purposes of the description of the invention herein, the following definitions apply:

The term, “aromachemical”, as used herein refers to a chemical compound that has fragrance and/or flavor characteristics.

The term “organoleptic”, as used herein, refers to compounds of the invention which stimulate the sense of smell or taste, and are thus perceived as having a characteristic odor and/or flavor.

An “organoleptically effective amount” of a compound of the invention is an amount of a compound which when broken down to provide the aromachemical on which it is based exhibit(s) a sensory effect acceptable to a consumer, e.g. by stimulating the sense of smell or taste.

The term, “organoleptically acceptable” (for example when used in relation to the counterion (X) and the sulfiting agent described herein) refers to materials compatible with the derivatives of the invention and which do not affect the organoleptic properties of the latter.

“Unit dosage form” refers to a composition containing a predetermined amount of a compound of the invention in a form for application to a product.

“Organoleptically acceptable carrier” refers to the material employed for delivery of a compound of the invention to the desired substrate, e.g., water or other solvent in which the derivative is soluble or may be suitably suspended.

The terms “pro-odorant” and “pro-flavorant” refer to compounds which themselves have substantially no odor or flavor but degrade over time and/or under certain conditions to provide the odorant or flavorant molecule on which they are based and thus provide the odor or flavor of that parent molecule.

The term “food product” includes any product suitable for ingestion, be it food and/or drink or one or more components of food and/or drink.

1. In a method for imparting a flavor to a product, said method comprising adding to said product an organoleptically effective amount of a dicarbonyl or mixtures thereof, the improvement comprising substituting for said dicarbonyl, an organoleptically acceptable derivative thereof having the formula: 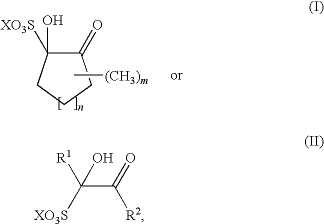
wherein m=0, 1 or 2, n=1 or 2, R¹ and R² are, independently, linear or branched saturated C₁₋₄ alkyl, with the proviso that both of R¹ and R² may not be methyl, and X is a counterion.

2. The method of claim 1 wherein said salt is a physiologically acceptable salt.

3. The method of claim 2 wherein said salt is an alkali metal.

4. The method of claim 3 wherein said salt is a sodium salt.

5. The method of claim 1 wherein said product is a food product.

6. The method of claim 5 wherein said food product is popcorn, sauces, soups, margarine, creams, desserts, butter, milk, cream, cheese, etc. also berry flavors, butterscotch, caramel, chocolate, coffee, cherry, fruit, honey, liquor, tobacco, rum, wine, nut, almond, spice, ginger ale, cream soda, vinegar, vanilla or buttermilk.

7. A process according to claim 1, which includes the step of subjecting the additive to conditions which cause the additive to break down to release the parent diacetyl.

8. A process according to claim 7, wherein the step of subjecting the derivative to conditions which cause the derivative to break down comprises subjecting the compound of formula (I) or (II) to acidic or basic conditions.

9. A product containing an organoleptically effective amount of an additive of formula I or II or mixtures thereof.

10. The product of claim 9 wherein said salt is a physiologically acceptable salt.

11. The product of claim 10 wherein said salt is an alkali metal.

12. The product of claim 11 wherein said salt is a sodium salt.

13. The product of claim 9 comprising a food product.

14. The product of claim 13 wherein said food product is popcorn, sauces, soups, margarine, creams, desserts, butter, milk, cream, cheese, etc. also berry flavors, butterscotch, caramel, chocolate, coffee, cherry, fruit, honey, liquor, tobacco, rum, wine, nut, almond, spice, ginger ale, cream soda, vinegar, vanilla or buttermilk.

15. An article of manufacture comprising the product of claim 9.

16. An article of manufacture in kit form comprising separate packaging materials and a product contained within one of said packaging materials, and an additive contained within the other of said packaging materials and wherein at least one of said packaging materials comprises a label which indicates that said additive can be used for imparting a butter flavor to said product, and wherein said additive is one or a mixture of formula I or II of claim 1.

17. The article of manufacture of claim 16 wherein said salt is a physiologically acceptable salt.

18. The article of manufacture of claim 17 wherein said salt is an alkali metal salt.

19. The article of manufacture of claim 18 wherein said alkali metal is sodium.

20. The article of manufacture of claim 16 wherein said product is popcorn, sauces, soups, margarine, creams, desserts, butter, milk, cream, cheese, etc. also berry flavors, butterscotch, caramel, chocolate, coffee, cherry, fruit, honey, liquor, tobacco, rum, wine, nut, almond, spice, ginger ale, cream soda, vinegar, vanilla or buttermilk.

21. A composition in unit dosage form comprising an organoleptically acceptable derivative of a dicarbonyl or mixture thereof and an organoleptically acceptable carrier therefore, said dicarbonyl having a formula I or II of claim 1, wherein the derivative is present in said composition in an amount sufficient to impart an organoleptically effective flavor to a product to which the composition is added.

22. The composition of claim 21 wherein said salt is a physiologically acceptable salt.

23. The composition of claim 22 wherein said salt is an alkali metal salt.

24. The composition of claim 23 wherein said alkali metal is sodium.

25. The composition of claim 21 wherein said product is popcorn, sauces, soups, margarine, creams, desserts, butter, milk, cream, cheese, etc. also berry flavors, butterscotch, caramel, chocolate, coffee, cherry, fruit, honey, liquor, tobacco, rum, wine, nut, almond, spice, ginger ale, cream soda, vinegar, vanilla or buttermilk.

26. The use of an organoleptically acceptable additive or a mixture thereof to impart a butter flavor to a product wherein said additive has the formula I or II of claim 1.

27. The use of claim 26 wherein said product is a food product.

28. The use of claim 26 wherein said salt is a physiologically acceptable salt.

29. The use of claim 28 wherein said salt is an alkali metal salt.

30. The use of claim 29 wherein said alkali metal is sodium.

31. The use of claim 26 wherein said product is popcorn, sauces, soups, margarine, creams, desserts, butter, milk, cream, cheese, etc. also berry flavors, butterscotch, caramel, chocolate, coffee, cherry, fruit, honey, liquor, tobacco, rum, wine, nut, almond, spice, ginger ale, cream soda, vinegar, vanilla or buttermilk.
